(19) United States
(12) Patent Application Publication
(10) Pub. No.: US 2014/0050955 A1
(43) Pub. Date: Feb. 20, 2014

(54) MECHANICAL SUPPORT STRUCTURE IN A BATTERY POUCH

(71) Applicant: APPLE INC., Cupertino, CA (US)

(72) Inventors: Richard M. Mank, Cupertino, CA (US); Taisup Hwang, Santa Clara, CA (US); Bookeun Oh, Fremont, CA (US)

(73) Assignee: APPLE INC., Cupertino, CA (US)

(21) Appl. No.: 13/627,175

(22) Filed: Sep. 26, 2012

Related U.S. Application Data
(60) Provisional application No. 61/683,464, filed on Aug. 15, 2012.

(51) Int. Cl. H01M 10/36; H01M 10/04

(52) U.S. Cl. 429/94; 29/623.1; 29/623.2

(57) ABSTRACT

The described embodiments relate to the design of a package for a battery cell. This battery cell includes a jelly roll with layers that are wound together, including a cathode with an active coating, a separator, and an anode with an active coating. Moreover, a pouch encloses the battery cell. Furthermore, a mechanical support structure, within the pouch, surrounds a portion of an outer surface of the jelly roll.

### CROSS REFERENCE TO RELATED APPLICATION

This application claims priority under 35 U.S.C. §119(e) to U.S. Provisional Application Ser. No. 61/683,464, entitled “Mechanical Support Structure in a Battery Pouch,” by Richard M. Mank, Taisup Hwang, and Bookeun Oh, Attorney docket number APL-P16905USP1, filed on Aug. 15, 2012, the contents of which is herein incorporated by reference.

### BACKGROUND

1. Field

The disclosed embodiments relate to batteries for portable electronic devices. More specifically, the present embodiments relate to battery cells that include mechanical support structures within the battery-cell pouches.

2. Related Art

Portable electronic devices, such as laptop computers, portable media players, and/or cellular telephones, typically operate using a rechargeable battery. Rechargeable batteries for portable electronic devices often include lithium-polymer batteries, which contain cells packaged in flexible pouches. Such pouches are typically lightweight and inexpensive to manufacture. Moreover, these pouches may be tailored to various cell dimensions, allowing lithium-polymer batteries to be used in space-constrained portable electronic devices such as cellular telephones, laptop computers, and/or digital cameras. For example, a lithium-polymer battery cell may achieve a packaging efficiency of 90-95% by enclosing rolled electrodes and electrolyte (which is sometimes referred to as a ‘jelly roll’) in an aluminized laminated pouch. Multiple pouches may then be placed side-by-side within a portable electronic device and electrically coupled in series and/or in parallel to form a battery for the portable electronic device.

In order to efficiently use the space in portable electronic devices, some existing rechargeable batteries do not include an external housings or battery-cell enclosures to protect the battery cells. Instead the battery cells and enclosing pouches may be directly attached to the structures within portable electronic devices. While this design choice can maximize the available energy volume, the battery cells in these rechargeable batteries are often subject to more mechanical stress and potential damage due to battery-cell deformation, for example, when the battery cells are handled during manufacturing. Damaged battery cells can significantly degrade the operating life of rechargeable batteries.

### SUMMARY

The described embodiments relate to the design of a package for a battery cell. This battery cell includes a jelly roll with layers that are wound together, including a cathode with an active coating, a separator, and an anode with an active coating. Moreover, a pouch encloses the battery cell. Furthermore, a mechanical support structure, within the pouch, surrounds a portion of an outer surface of the jelly roll.

For example, the outer surface of the jelly roll may include ends and a central region, and the portion of the outer surface surrounded by the mechanical support structure may include the central region and/or the ends. In particular, the portion of the outer surface surrounded by the mechanical support structure may include corners of the jelly roll.

Note that the mechanical support structure may comprise a plastic material.

In some embodiments, the pouch includes a first cup in a flexible sheet of pouch material and a second cup in the flexible sheet. The pouch may be formed by folding the second cup over the first cup. Moreover, the pouch may include a layer of aluminum and a layer of polypropylene.

Another embodiment provides an electronic device that includes a set of components powered by a battery pack that includes the battery cell.

Another embodiment provides a method for manufacturing the battery cell. During the method, the mechanical support structure is positioned over the jelly roll so that the mechanical support structure surrounds the portion of the outer surface of the jelly roll, wherein the jelly roll includes layers that are wound together, including the cathode with the active coating, the separator, and the anode with the active coating. Then, the jelly roll and the mechanical support structure are enclosed within the pouch.

In some embodiments, enclosing the jelly roll and the mechanical support structure involves: obtaining a flexible sheet of pouch material; forming a first cup and a second cup in the flexible sheet; creating the pouch to accommodate the jelly roll and the mechanical support structure by folding the second cup over the first cup; and forming the seal by sealing the jelly roll and the mechanical support structure in the pouch along a rim of the first and second cups.

Additionally, the method may involve: coupling a first conductive tab to the cathode of the jelly roll; coupling a second conductive tab to the anode of the jelly roll; and extending the first and second conductive tabs through the seal to provide terminals for the battery cell.

### BRIEF DESCRIPTION OF THE FIGURES

FIG. 1 is a block diagram illustrating a top-down view of a battery cell in accordance with an embodiment.

FIG. 2 is a block diagram illustrating a jelly roll in the battery cell of FIG. 1 in accordance with an embodiment.

FIG. 3 is a block diagram illustrating a cross-sectional view of the battery cell of FIG. 1 in accordance with an embodiment.

FIG. 4 is a block diagram illustrating the creation of a pouch for the battery cell of FIGS. 1 and 3 from a flexible sheet of pouch material in accordance with an embodiment.

FIG. 5 is a drawing illustrating the function of the mechanical support structure in the battery cell of FIGS. 1 and 3 in accordance with an embodiment.

FIG. 6 is a flowchart illustrating a method of manufacturing a battery cell in accordance with an embodiment.

FIG. 7 is a drawing illustrating a portable electronic device in accordance with an embodiment.

Note that like reference numerals refer to corresponding parts throughout the drawings. Moreover, multiple instances of the same part are designated by a common prefix separated from an instance number by a dash.

### DETAILED DESCRIPTION

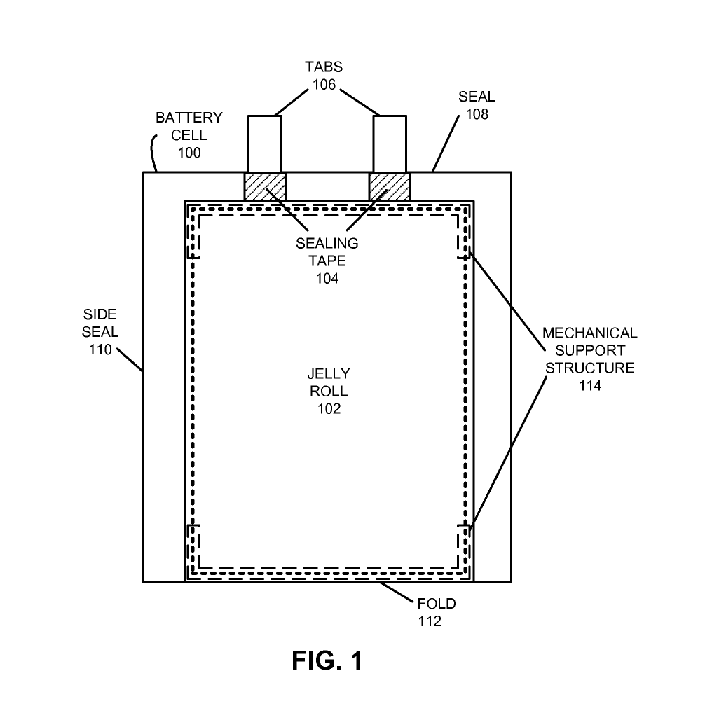

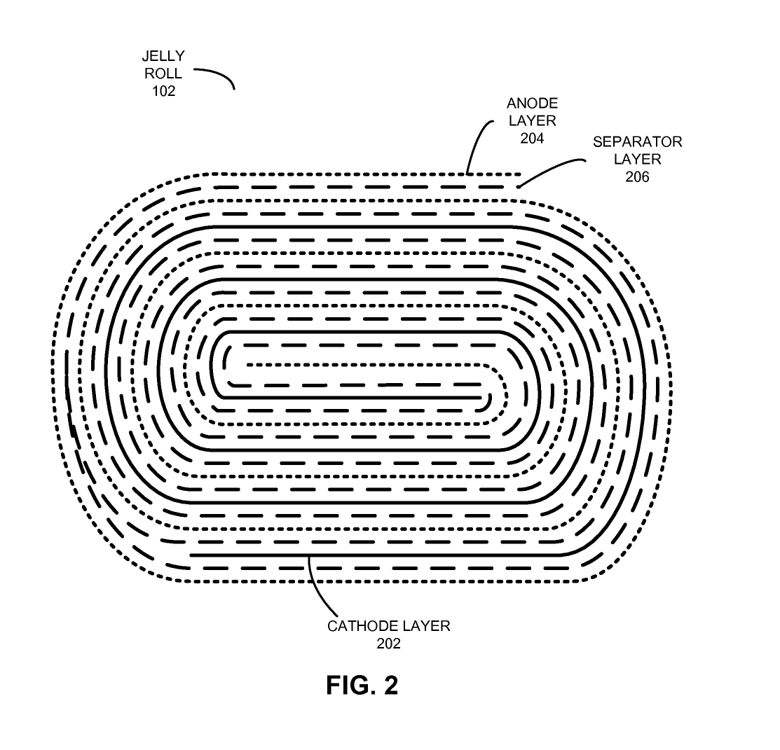

FIG. 1 presents a block diagram illustrating a top-down view of a battery cell 100. Battery cell 100 may correspond to a lithium-polymer cell that is used to power a portable electronic device. Moreover, battery cell 100 may include a jelly roll 102 with a number of layers that are wound together, including a cathode with an active coating, a separator, and an anode with an active coating. More specifically, as shown in FIG. 2, jelly roll 102 may include one cathode strip or layer 202 (e.g., aluminum foil coated with a lithium compound) and one anode strip or layer 204 (e.g., copper foil coated with carbon) separated by one separator strip or layer 206 (e.g., conducting polymer electrolyte). Moreover, cathode layer 202, anode layer 204, and separator layer 206 may then be wound on a mandrel to form a spirally wound structure. Jelly rolls are well known in the art and will not be described further.

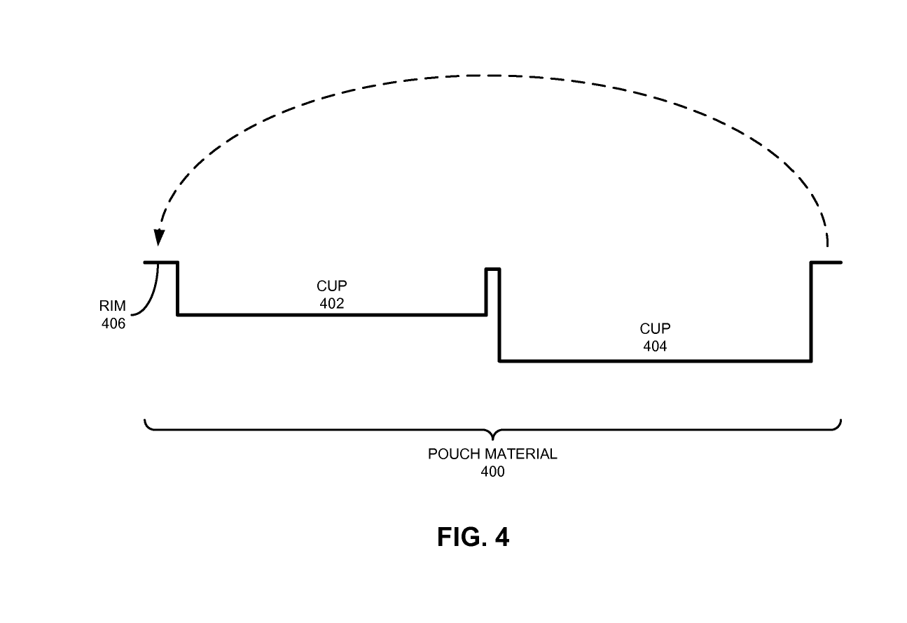

Referring back to FIG. 1, during assembly of battery cell 100 jelly roll 102 is enclosed in a flexible pouch, which, as described further below with reference to FIG. 4, is formed by folding a flexible sheet along a fold line 112. For example, the flexible sheet may be made of aluminum with a polymer film, such as polypropylene. After the flexible sheet is folded, the flexible sheet can be sealed, for example, by applying heat along a side seal 110 and along a seal 108.

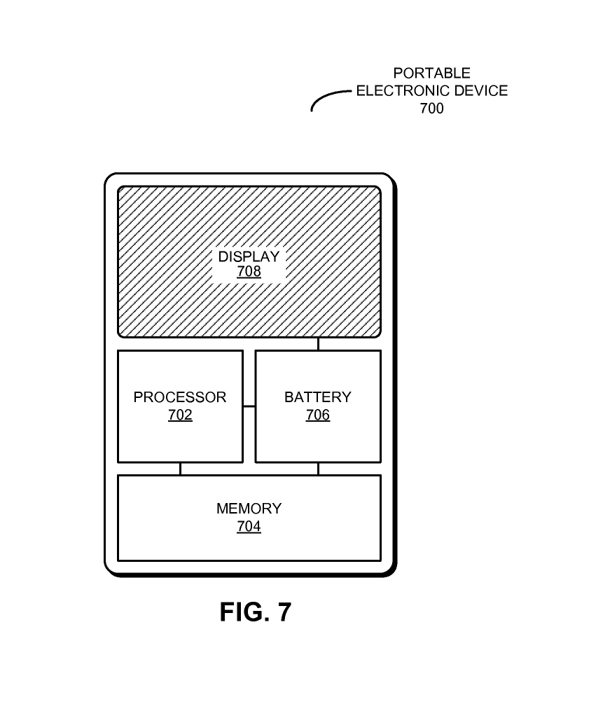

Jelly roll 102 also includes a set of conductive tabs 106 coupled to the cathode and the anode. Conductive tabs 106 may extend through seals in the pouch (for example, formed using sealing tape 104) to provide terminals for battery cell 100. Conductive tabs 106 may then be used to electrically couple battery cell 100 with one or more other battery cells to form a battery pack. For example, the battery pack may be formed by coupling the battery cells in a series, parallel, or series-and-parallel configuration. As described further below with reference to FIG. 7, the coupled battery cells may be enclosed may be embedded within the enclosure of a portable electronic device, such as a laptop computer, tablet computer, mobile phone, personal digital assistant (PDA), digital camera, and/or portable media player.

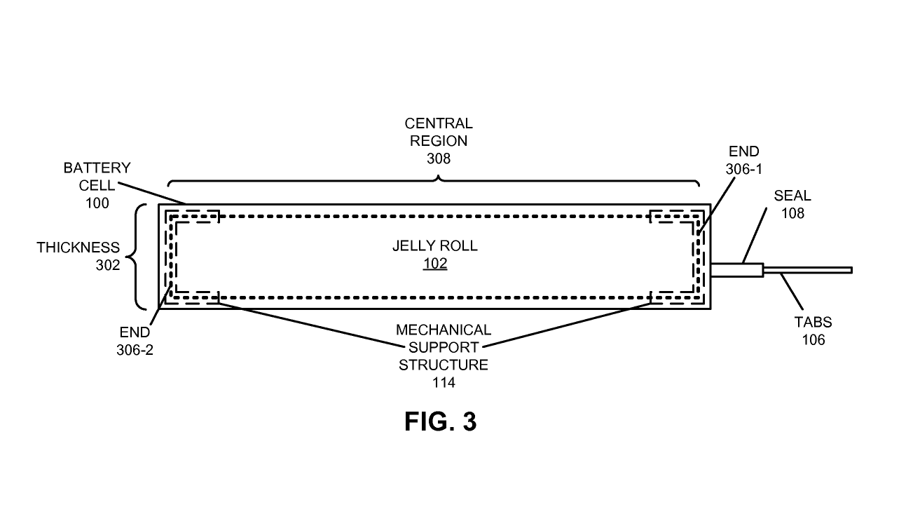

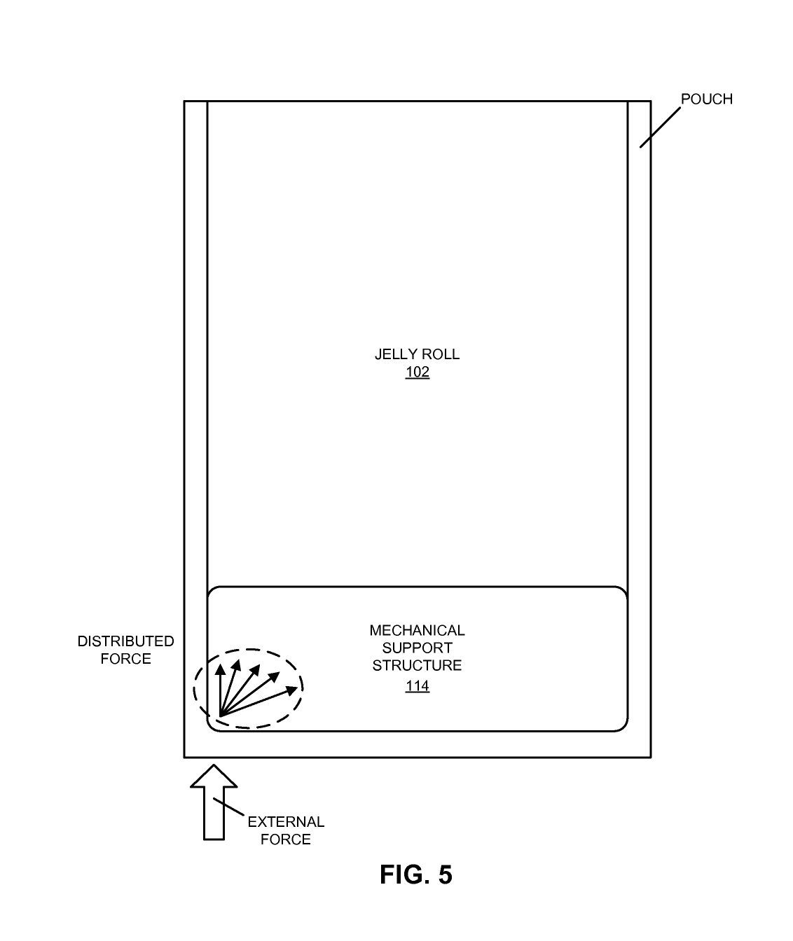

Note that the battery pack may be constructed without external battery-cell enclosures, such as one or more external mechanical housing (outside of the pouch) that encloses the battery cell(s). However, in order to provide mechanical support and protection, battery cell 100 may also include mechanical support structure 114, within the pouch, which surrounds a portion of an outer surface of jelly roll 102. For example, FIG. 3 presents a block diagram illustrating a cross-sectional view of battery cell 100. Note that the outer surface of jelly roll 102 may include ends 306 and a central region 308, and the portion of the outer surface surrounded by mechanical support structure 114 may include ends 306 and/or central region 308. As described further below with reference to FIG. 5, the portion of the outer surface surrounded by mechanical support structure 114 may include corners of jelly roll 102. Thus, as illustrated in FIGS. 1 and 3, mechanical support structure 114 may be positioned on the top and the bottom of jelly roll 102. Note that the mechanical support structure 114 may comprise a plastic material, such as polyethylene or polypropylene.

As noted previously, battery cell 100 may be included in a battery pack. This battery pack may include or may be electrically coupled to a battery management unit (BMU) that manages use of the battery pack in a portable electronic device such as a mobile phone, PDA, laptop computer, tablet computer, portable media player, digital camera, and/or other type of battery-powered electronic device. For example, the BMU may correspond to an integrated circuit that obtains measurements of voltage, current, temperature, and/or other parameters associated with battery cell 100. The BMU may use the measurements to assess the state of charge, capacity, and/or health of battery cell 100. The BMU may also adjust the charging and/or discharging of battery cell 100 based on the assessed state of charge, capacity, and/or health. Alternatively, battery cell 100 may be electrically coupled by a bus bar and/or another electrical component to a BMU and/or to other battery cells in the battery pack.

FIG. 4 presents a block diagram illustrating the creation of a pouch for battery cell 100 (FIGS. 1 and 3) from a flexible sheet of pouch material 400. As mentioned previously, pouch material 400 may contain a layer of aluminum and a layer of propylene. To create the pouch, a first cup 402 and a second cup 404 are formed in pouch material 400.

In one or more embodiments, cups 402-404 are formed by punching a first indentation corresponding to the cup 402 in pouch material 400 and punching a second indentation corresponding to cup 404 in pouch material 400. For example, a shallow die may be used to form cup 402, and a deeper die may be used to form cup 402. Cup 404 may then be folded over cup 402, and seal 108 (FIGS. 1 and 3) may be formed by sealing a jelly roll in the pouch along a rim 406 of cups 402-404.

Consequently, cup 402 may correspond to the bottom of battery cell 100 (FIGS. 1 and 3), and cup 404 may correspond to the top of battery cell 100 (FIGS. 1 and 3). Moreover, cups 402-404 may have different depths to enable the formation of a seal in battery cell 100 (FIGS. 1 and 3). Because cup 402 is shallower than cup 404, the seal may be formed along the bottom half of battery cell 100 (FIGS. 1 and 3). Alternatively, the seal may be adjusted to be closer to the top half of battery cell 100 (FIGS. 1 and 3) by increasing the relative depth of cup 402 and decreasing the relative depth of cup 404. Thus, as shown in FIG. 3, seal 108 may be adjusted along thickness 302 to facilitate efficient use of space inside a portable electronic device powered by battery cell 100.

In an exemplary embodiment, when an external battery-cell enclosure is excluded, the battery cell can be easily deformed by an external force. In order to maintain mechanical integrity from mechanical abuse by a user or an external force during the battery-cell-handling process, the mechanical support structure with the pouch may be included.

As shown in FIG. 5, presents a drawing illustrating the function of the mechanical support structure in battery cell 100 (FIGS. 1 and 3), the top and bottom of a lithium-polymer battery cell may be vulnerable to mechanical abuses, such as shock, vibration, and, drop. In particular, while the anode and cathode electrodes should be electrically insulated for full electrical performance and reliability, if the electrodes are damaged or compromised by the external force, it may cause an internal soft or hard short. As a consequence, the battery-cell capacity (e.g., the run-time of portable electronic device that includes the battery) may be significantly reduced.

The mechanical support structure at the top and bottom of the jelly roll can disperse external forces, thereby maintaining good alignment of the electrodes. By protecting the lithium-polymer battery cell from external forces, the external battery-cell housing can be safely removed, which may allow the energy volume to be maximized without compromising run-time or reliability.

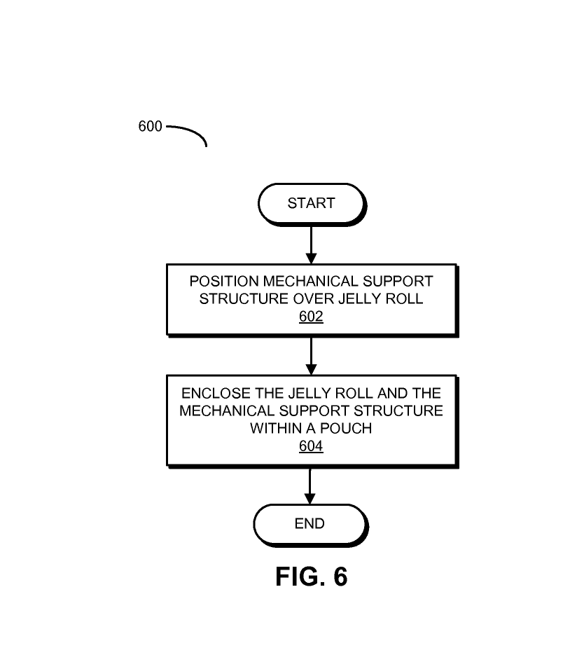

The battery cell may be manufactured in a way that facilitates efficient use of space within a portable electronic device while providing mechanical support, as well as protection from vibration and mechanical shock. More specifically, FIG. 6 presents a flowchart illustrating a method 600 of manufacturing a battery cell, such as battery cell 100 (FIGS. 1 and 3). During method 600, a mechanical support structure is positioned over a jelly roll (operation 602)so that a mechanical support structure surrounds a portion of an outer surface of the jelly roll, wherein the jelly roll includes layers that are wound together, including a cathode with an active coating, a separator, and an anode with the active coating. Then, the jelly roll and the mechanical support structure are enclosed within a pouch (operation 604).

In some embodiments, enclosing the jelly roll and the mechanical support structure involves: obtaining a flexible sheet of pouch material; forming a first cup and a second cup in the flexible sheet; creating the pouch to accommodate the jelly roll and the mechanical support structure by folding the second cup over the first cup; and forming the seal by sealing the jelly roll and the mechanical support structure in the pouch along a rim of the first and second cups.

Additionally, the method may involve: coupling a first conductive tab to the cathode of the jelly roll; coupling a second conductive tab to the anode of the jelly roll; and extending the first and second conductive tabs through the seal to provide terminals for the battery cell.

In some embodiments of method 600, there may be additional or fewer operations. Moreover, the order of the operations may be changed, and/or two or more operations may be combined into a single operation.

FIG. 7 presents a drawing illustrating a portable electronic device 700 that includes a battery 706 with a battery pack and one or more battery cells, such as battery cell 100 (FIGS. 1 and 3). This portable electronic device includes a processor 702, a memory 704, and a display 708. Processor 702 includes one or more devices configured to perform computational operations. For example, processor 702 can include one or more microprocessors, application-specific integrated circuits (ASICs), microcontrollers, programmable-logic devices, and/or one or more digital signal processors (DSPs).

Memory 704 includes one or more devices for storing data and/or instructions for processor 702. For example, memory 704 can include dynamic random access memory (DRAM), static random access memory (SRAM), and/or other types of memory. In some embodiments, instructions for processor 702 in memory 704 include: one or more program modules or sets of instructions, which may be executed by processor 702. Note that the one or more computer programs may constitute a computer-program mechanism. Moreover, instructions in the various modules in memory 704 may be implemented in: a high-level procedural language, an object-oriented programming language, and/or in an assembly or machine language. Furthermore, the programming language may be compiled or interpreted, e.g., configurable or configured, to be executed by processor 702.

In addition, memory 704 can include mechanisms for controlling access to the memory. In some embodiments, memory 704 includes a memory hierarchy that comprises one or more caches coupled to a memory in portable electronic device 700. In some of these embodiments, one or more of the caches is located in processor 702.

In some embodiments, memory 704 is coupled to one or more high-capacity mass-storage devices (not shown). For example, memory 704 can be coupled to a magnetic or optical drive, a solid-state drive, or another type of mass-storage device. In these embodiments, memory 704 can be used by portable electronic device 700 as fast-access storage for often-used data, while the mass-storage device is used to store less frequently used data.

While not shown in FIG. 7, in some embodiments portable electronic device 700 includes a communication subsystem with one or more devices that couple to and communicate on a wired and/or wireless network (i.e., to perform network operations). For example, the communication subsystem can include a Bluetooth™ networking system, a cellular networking system (e.g., a 3G/4G network such as UMTS, LTE, etc.), a Universal Serial Bus (USB) networking system, a networking system based on the standards described in IEEE 802.11 (e.g., a Wi-Fi networking system), an Ethernet networking system, and/or another networking system.

The communication subsystem can include processors, controllers, radios/antennas, sockets/plugs, and/or other devices used for coupling to, communicating on, and handling data and events for each supported networking system. Moreover, in some embodiments a ‘network’ between electronic devices does not yet exist. Therefore, portable electronic device 700 may use the mechanisms in the communication subsystem for performing simple wireless communication between electronic devices, e.g., transmitting advertising frames and/or scanning for advertising frames transmitted by other electronic devices.

Within portable electronic device 700, components may be coupled together using a bus and may be powered by a power source, such as battery 706. The bus may include an electrical, optical, and/or electro-optical connection that the subsystems and components can use to communicate commands and data among one another.

Furthermore, in the preceding embodiments, components are shown directly connected to one another or are shown connected via intermediate components. In each instance the method of interconnection, or ‘coupling,’ establishes some desired communication between two or more circuit nodes, or terminals. Such coupling may often be accomplished using a number of circuit configurations, as will be understood by those of skill in the art; for example, AC coupling and/or DC coupling may be used.

In some embodiments, portable electronic device 700 includes a display 708 for displaying information, such as a liquid-crystal display, a touchscreen, etc.

Portable electronic device 700 can be (or can be included in) any electronic device with at least one communication subsystem. For example, portable electronic device 700 can be (or can be included in): a laptop computer, a media player (such as an MP3 player), an appliance, a peripheral device (such as a trackpad, a touchscreen, a display, a mouse, a camera, a keyboard, a user-interface device, etc.), a subnotebook/netbook, a tablet computer, a smartphone, a cellular telephone, a piece of testing equipment, a network appliance, a set-top box, a personal digital assistant (PDA), a toy, a controller, a digital signal processor, a game console, a computational engine within an appliance, a consumer-electronic device, a portable computing device, a personal organizer, and/or another battery-powered electronic device.

Note that battery 706 may correspond to a battery pack that includes one or more battery cells. Each battery cell may include a jelly roll sealed in a pouch. The battery pack may also include or may be electrically coupled to a BMU.

Although specific components are used to describe portable electronic device 700, in alternative embodiments, different components and/or subsystems may be present in portable electronic device 700. For example, portable electronic device 700 may include one or more additional processors, memory, and/or displays. Additionally, one or more of the subsystems or components may not be present in portable electronic device 700. Moreover, in some embodiments, portable electronic device 700 may include one or more additional subsystems that are not shown in FIG. 7. For example, portable electronic device 700 can include, but is not limited to, a data collection subsystem, an audio and/or video subsystem, an alarm subsystem, a media processing subsystem, and/or an input/output (I/O) subsystem. Also, although separate subsystems are shown in FIG. 7, in some embodiments, some or all of a given subsystem or component can be integrated into one or more of the other subsystems or component(s) in portable electronic device 700.

Moreover, the circuits and components in portable electronic device 700 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

Note that an output of a process for designing an integrated circuit, or a portion of an integrated circuit, comprising one or more of the circuits described herein may be a computer-readable medium such as, for example, a magnetic tape or an optical or magnetic disk. The computer-readable medium may be encoded with data structures or other information describing circuitry that may be physically instantiated as an integrated circuit or portion of an integrated circuit. Although various formats may be used for such encoding, these data structures are commonly written in: Caltech Intermediate Format (CIF), CalmaGDS II Stream Format (GDSII) or Electronic Design Interchange Format (EDIF). Those of skill in the art of integrated circuit design can develop such data structures from schematics of the type detailed above and the corresponding descriptions and encode the data structures on a computer-readable medium. Those of skill in the art of integrated circuit fabrication can use such encoded data to fabricate integrated circuits comprising one or more of the circuits described herein.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A battery cell, comprising:
a jelly roll with layers that are wound together, including a cathode with an active coating, a separator, and an anode with an active coating;
a pouch enclosing the battery cell, wherein the jelly roll is sealed in the pouch; and
a mechanical support structure, within the pouch, that surrounds a portion of an outer surface of the jelly roll.

2. The battery cell of claim 1, wherein the outer surface of the jelly roll includes ends and a central region; and
wherein the portion of the outer surface surrounded by the mechanical support structure includes the central region.

3. The battery cell of claim 1, wherein the outer surface of the jelly roll includes ends and a central region; and
wherein the portion of the outer surface surrounded by the mechanical support structure includes the ends.

4. The battery cell of claim 1, wherein the portion of the outer surface surrounded by the mechanical support structure includes corners of the jelly roll.

5. The battery cell of claim 1, wherein the mechanical support structure comprises a plastic material.

6. The battery cell of claim 1, wherein the pouch includes:
a first cup in a flexible sheet of pouch material; and
a second cup in the flexible sheet, wherein the pouch is formed by folding the second cup over the first cup.

7. The battery cell of claim 7, wherein the pouch includes:
a layer of aluminum; and
a layer of polypropylene.

8. A portable electronic device, comprising:
a set of components powered by a battery pack; and
the battery pack including a battery cell, wherein the battery cell includes:
a jelly roll with layers that are wound together, including a cathode with an active coating, a separator, and an anode with an active coating;
a pouch enclosing the battery cell, wherein the jelly roll is sealed in the pouch; and
a mechanical support structure, within the pouch, that surrounds a portion of an outer surface of the jelly roll.

9. The portable electronic device of claim 8, wherein the outer surface of the jelly roll includes ends and a central region; and
Wherein the portion of the outer surface surrounded by the mechanical support structure includes the central region.

10. The portable electronic device of claim 8, wherein the outer surface of the jelly roll includes ends and a central region; and
wherein the portion of the outer surface surrounded by the mechanical support structure includes the ends.

11. The portable electronic device of claim 8, wherein the portion of the outer surface surrounded by the mechanical support structure includes corners of the jelly roll.

12. The portable electronic device of claim 8, wherein the mechanical support structure comprises a plastic material.

13. The portable electronic device of claim 8, wherein the pouch includes:
a first cup in a flexible sheet of pouch material; and
a second cup in the flexible sheet, wherein the pouch is formed by folding the second cup over the first cup.

14. The portable electronic device of claim 13, wherein the pouch includes:
a layer of aluminum; and
a layer of polypropylene.

15. A method for manufacturing a battery cell, comprising:
positioning a mechanical support structure over a jelly roll so that the mechanical support structure surrounds a portion of an outer surface of the jelly roll, wherein the jelly roll includes layers that are wound together, including a cathode with an active coating, a separator, and an anode with an active coating; and
enclosing the jelly roll and the mechanical support structure within a pouch.

16. The method of claim 15, wherein enclosing the jelly roll and the mechanical support structure involves:
obtaining a flexible sheet of pouch material;
forming a first cup and a second cup in the flexible sheet;
creating the pouch to accommodate the jelly roll and the mechanical support structure by folding the second cup over the first cup; and
forming a seal by sealing the jelly roll and the mechanical support structure in the pouch along a rim of the first and second cups.

17. The method of claim 15, further comprising:
coupling a first conductive tab to the cathode of the jelly roll;
coupling a second conductive tab to the anode of the jelly roll; and
extending the first and second conductive tabs through the seal to provide terminals for the battery cell.

18. The method of claim 15, wherein the mechanical support structure comprises a plastic material.

19. The method of claim 15, wherein the portion of the outer surface surrounded by the mechanical support structure includes corners of the jelly roll.

20. The method of claim 15, wherein the outer surface of the jelly roll includes ends and a central region; and
wherein the portion of the outer surface surrounded by the mechanical support structure includes the central region.

21. The method of claim 15, wherein the outer surface of the jelly roll includes ends and a central region; and
wherein the portion of the outer surface surrounded by the mechanical support structure includes the ends.
